(19) United States
(12) Patent Application Publication
(10) Pub. No.: US 2007/0077392 A1
(43) Pub. Date: Apr. 5, 2007

(54) E-Z mark

(76) Inventors: Matthew Martin Winter, Ramona, CA (US); Jason Neal Winter, Ramona, CA (US)

Correspondence Address: MATTHEW M. WINTER, 1425 CEDAR ST., RAMONA, CA, 92065, US

(21) Appl. No.: 11/350,370

(22) Filed: May 1, 2006

Related U.S. Application Data
(60) Provisional application No. 60/722,699, filed on Oct. 3, 2005.

(51) Int. Cl. B32B 3/10

(52) U.S. Cl. 428/131; 428/544

(57) ABSTRACT

The E-Z Mark was designed by the working man for the working man. It's compatible with most standard tape measure's. It will cut your time in half when taking a measurement. It not only makes an exact mark at your desired location, it holds your sharpie permanent marker with your measuring device at all times. This allows you to use your free hand for other task's and will save you time and money when you never lose your marker again. The scale drawing on page 1 is measured to thousandths of an inch. Refer to page 4 of the drawings for a more accurate picture of the E-Z mark.

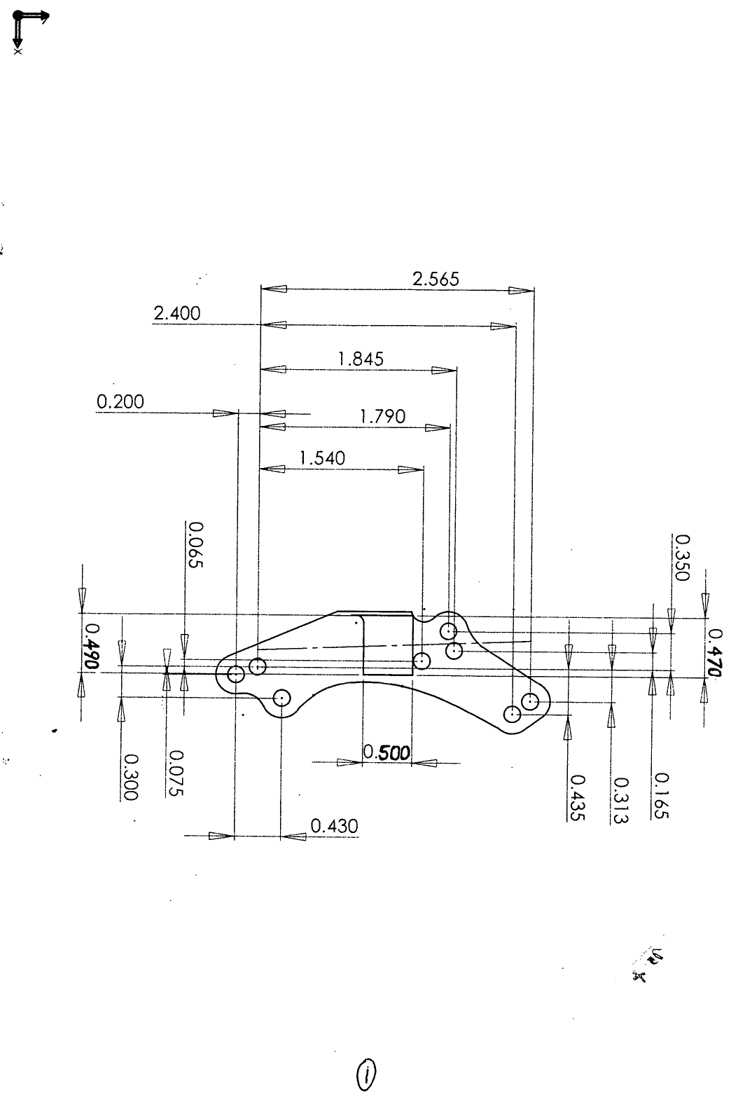

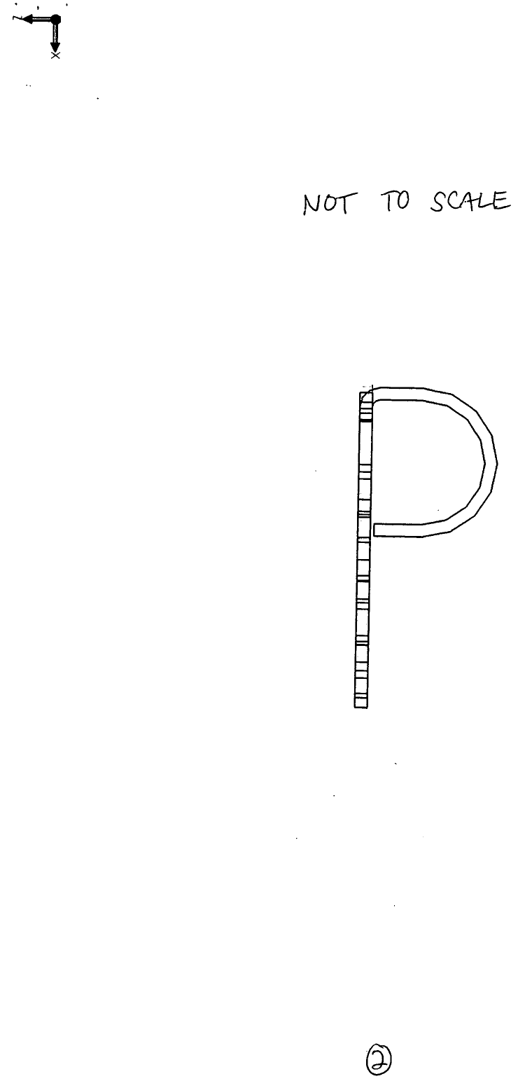

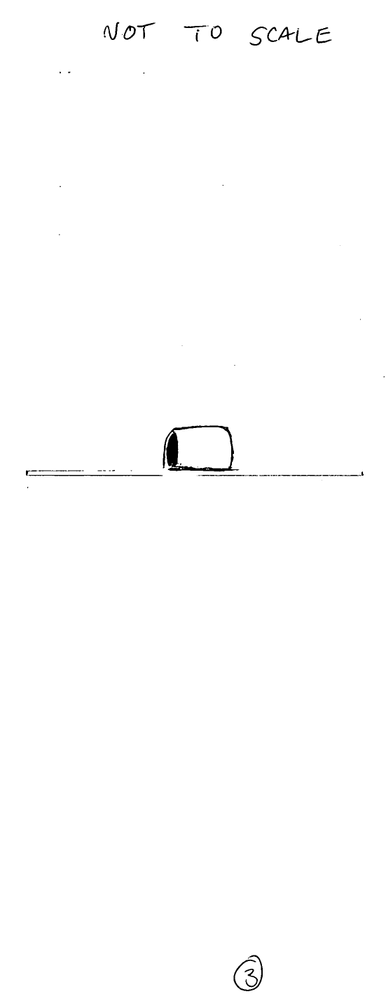

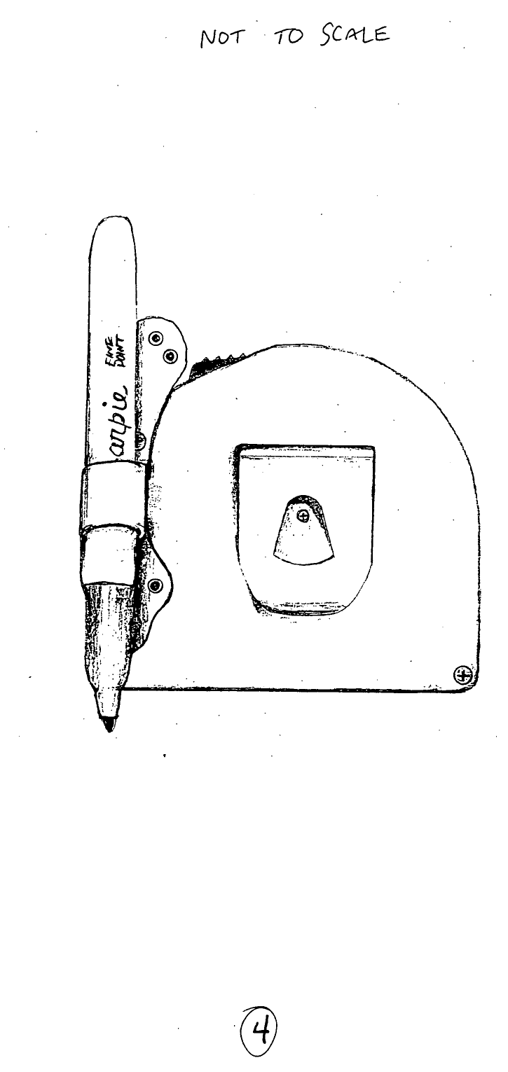

The purpose for inventing and designing the E-Z Mark tool was to provide an accurate mark or line on the desired object. The E-Z Mark also acts as holder for a Sharpie pen, keeping the tape measure with the writing utensil at all times. This tool is compatible with most standard construction grade tape measure's.

The E-Z Mark is made out of 18 gauge stainless steel sheet metal. It is the laser cut to our specific dimensions. With a template of exact dimensions the holes are center punched and drilled out with a ⅛ inch drill bit. The eight holes allows the E-Z Mark to be compatible with most Stanley and Craftsman tape measure's. The piece is then clamped into a jig which rolls the part of the tool designed as a holder for the pen. It rolls the material around a tapered rod so the pen fits snug. The E-Z Mark is complete and ready for installation.

Remove the two screws closest to the front of the tape measure. Line up holes with tape measure desired and fasten using existing screws. Longer screws will be provided in packaging for those tape measure's that require them.

1. What we claim as our invention is described in paragraphs [0001], [0002] and [0003] of the specification.
